(19) United States
(12) Patent Application Publication
(10) Pub. No.: US 2023/0133043 A1
(43) Pub. Date: May 4, 2023

(54) BNC WITH INTERGRATED SWITCH

(71) Applicant: COMTEST NETWORKS INC., Ottawa (CA)

(72) Inventors: Rod Farrell, Ottawa (CA); Shawn Delay, Nepean (CA); Savo Todoric, Nepean (CA); Matthew Tessier, L'Ange-Gardien (CA); William Fry, Ottawa (CA)

(21) Appl. No.: 17/809,774

(22) Filed: Jun. 29, 2022

Related U.S. Application Data
(60) Provisional application No. 63/274,735, filed on Nov. 2, 2021.

(51) Int. Cl. H01R 13/703

(52) U.S. Cl. CPC H01R 13/703; H01R 13/625

(57) ABSTRACT

Bayonet Neill-Concelman (BNC) connector are disclosed. The BNC connector comprises: an insulating housing; a signal receiver mounted in the housing for receiving a signal from a BNC plug; and a switch mounted in the housing and configured to connect to a first circuit, and when the BNC plug is connected to the BNC connector, the switch configured to connect to a second circuit for the second circuit.

### CROSS-REFERENCE

The present application claim priority over the U.S. provisional application No. 63/274,735, entitled “BNC RA WITH INTEGRATED SWITCH”, filed on Nov. 2, 2021, which is incorporated in this disclosure in its entirety.

### FIELD

The present invention relates to a communication connector, and more particularly to a Bayonet Neill-Concelman (BNC) connector.

### BACKGROUND

BNC connectors are commonly used in communications. However, existing BNC connectors either cannot provide flexibility to control signal received, or often have a complex structure for manufacture and assembly.

### SUMMARY

The present disclosure discloses a BNC connector with an integrated switch to selectively connect the BNC connector to different circuits. With the switch within the BNC connector, the need for external switches, linkages between the switches and the connectors and additional Radio Frequency (RF) shielding around the external components are eliminated.

The BNC connector in the present disclosure has a simplified structure and significantly simplifies manufacturing and assembling process of the BNC connector. In an aspect, the BNC connector is a signal pass-through with 2 isolated switches that are activated via a double throw action when a mating BNC plug is inserted to the BNC connector. The configuration of the BNC connector allows multiple variations of the received signal path to be connected to one or more of circuits on a PCB, or have the circuits act as isolated circuits by the insertion and removal of the mating BNC plug.

In another aspect, there is provided a Bayonet Neill-Concelman (BNC) connector, which comprises: an insulating housing; a signal receiver mounted in the housing for receiving a signal from a BNC plug; and a switch mounted in the housing and configured to connect to a first circuit, and when the BNC plug is connected to the BNC connector, the switch configured to connect to a second circuit for the second circuit.

In another aspect, in the BNC connector of preceding aspects, the switch comprises a left arm and a right arm configured to selectively connect to the first circuit and the second circuit.

In another aspect, in the BNC connector of preceding aspects, each of the left arm and the right arm has a rear portion for connecting to a first pin, a front portion for connecting to a second pin, and a protruded portion between the rear portion and the front portion.

In another aspect, in the BNC connector of preceding aspects, the front portion is substantially straight, and the rear portion is curved to a left or a right side.

In another aspect, in the BNC connector of preceding aspects, the switch further comprises a first pair of fixed arms configured for connecting to the first circuit, a second pair of fixed arms configured for connecting to the second circuit, and wherein the left arm and the right arm are configured to selectively connect to the first pair of fixed arms and the second pair of fixed arms.

In another aspect, in the BNC connector of preceding aspects, each of the first pair of fixed arms and the second pair of fixed arms has a contact point.

In another aspect, in the BNC connector of preceding aspects, the switch further comprises a pusher, and wherein when the BNC plug is connected to the BNC connector, the pusher is configured to be slidable in relation to the left arm and the right arm to cause the left arm and the right arm to connect from the first circuit to the second circuit.

In another aspect, in the BNC connector of preceding aspects, the pusher comprises a left prong and a right prong, each having a protrusion, wherein when the BNC plug is connected to the BNC connector, the protrusion of the left prong is configured to engages the protruded portion of the left arm, and the protrusion of the right prong is configured to engages the protruded portion of the right arm.

In another aspect, in the BNC connector of preceding aspects, the switch further comprises a biasing means for biasing the pusher, the biasing means configured to be in a compressed state when the BNC plug is connected to the BNC connector, and in an uncompressed state when the BNC plug is disconnected from the BNC connector.

In another aspect, in the BNC connector of preceding aspects, the biasing means is a spring.

In another aspect, in the BNC connector of preceding aspects, the pusher comprises a front portion received in the spring.

In another aspect, in the BNC connector of preceding aspects, the pusher comprises a front inner edge between the left prong and the right prong.

In another aspect, in the BNC connector of preceding aspects, the front inner edge is substantially straight.

In another aspect, in the BNC connector of preceding aspects, the front inner edge comprises a left protrusion for receiving a rear end of the left arm, and a right protrusion for receiving a rear end of the right arm.

In another aspect, in the BNC connector of preceding aspects, the left protrusion and the rear end of the left arm are curved, and the right protrusion and the rear end of the right arm are curved.

In another aspect, in the BNC connector of preceding aspects, each of the left prong and the right prong has a rear end configured to engage an edge of the BNC plug.

In another aspect, the BNC connector of preceding aspects further comprise a plurality conductive pins connecting to the signal receiver, the left arm, the right arm, the first pair of fixed arms, and the second pair of fixed arms.

In another aspect, in the BNC connector of preceding aspects, first two conductive pins are configured to connect to a first circuit on a PCB (Printed Circuit Board), and wherein second two conductive pins are configured to connect to a second circuit on the PCB.

In another aspect, in the BNC connector of preceding aspects, the insulating housing comprises first and second insulators configured to securely receive the signal receiver and the switch.

In another aspect, the BNC connector of preceding aspects further comprises a locking mechanism for retaining the spring in a compressed state when the BNC plug is secured to the BNC connector.

### BRIEF DESCRIPTION OF THE DRAWINGS

Reference will now be made, by way of example, to the accompanying drawings which show example embodiments of the present application, and in which:

FIG. 1A is a right perspective view of a BNC connector, according to an embodiment of the present application;

FIG. 1B is a bottom perspective view of the BNC connector in FIG. 1A;

FIG. 1C is a side view of the BNC connector in FIG. 1A;

FIG. 2 is an exploded perspective view of the BNC connector in FIGS. 1A-1C;

FIG. 3A is a side view of a left switch arm in FIG. 2, according to an embodiment;

FIG. 3B is a side view of a left switch arm in FIG. 2, according to another embodiment;

FIG. 4A is a side view of a right switch arm in FIG. 2, according to an embodiment;

FIG. 4B is a side view of a right switch arm in FIG. 2, according to another embodiment;

FIG. 5A is a plan view of a pusher in FIG. 2, according to an embodiment;

FIG. 5B is a plan view of a pusher in FIG. 2, according to another embodiment;

FIG. 6A is a cross-sectional view of the BNC connector in FIGS. 1A-1C in a default position, according to an embodiment;

FIG. 6B is an enlarged partial view of portion A in FIG. 6A,;

FIG. 7A is a bottom view of the BNC connector in FIGS. 1A-1C;

FIG. 7B is a switch diagram of the BNC connector in FIGS. 1A-1C;

FIG. 8A is a cross-sectional view of the BNC connector in

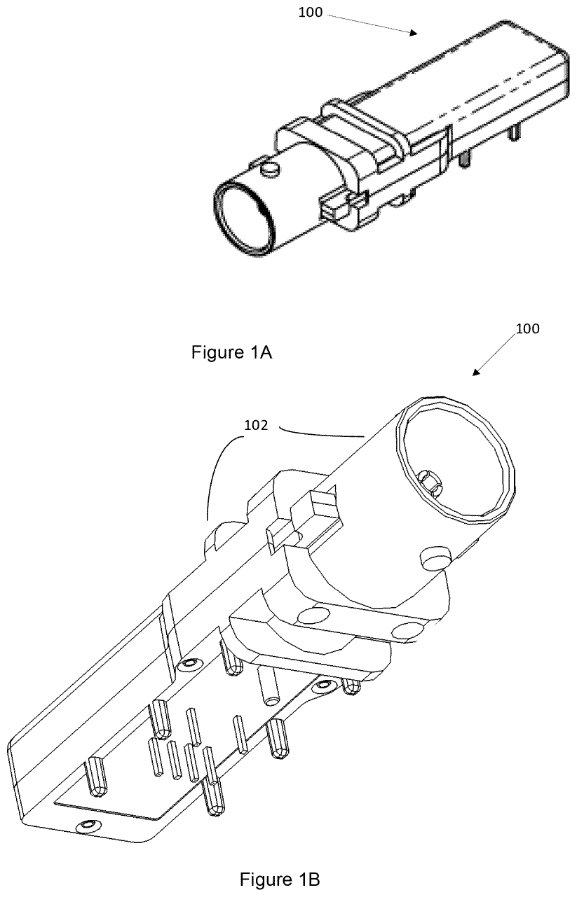

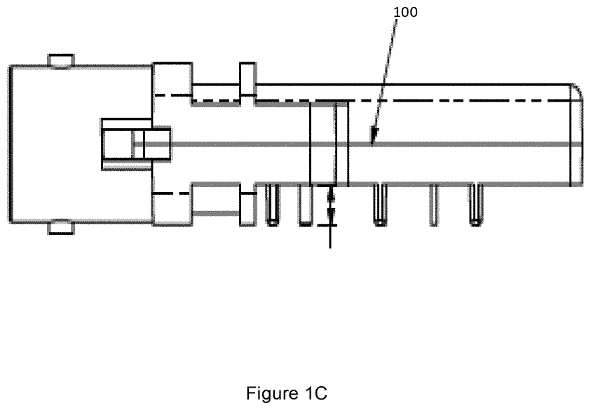

FIGS. 1A-1C connected to a BNC plug, according to an embodiment;

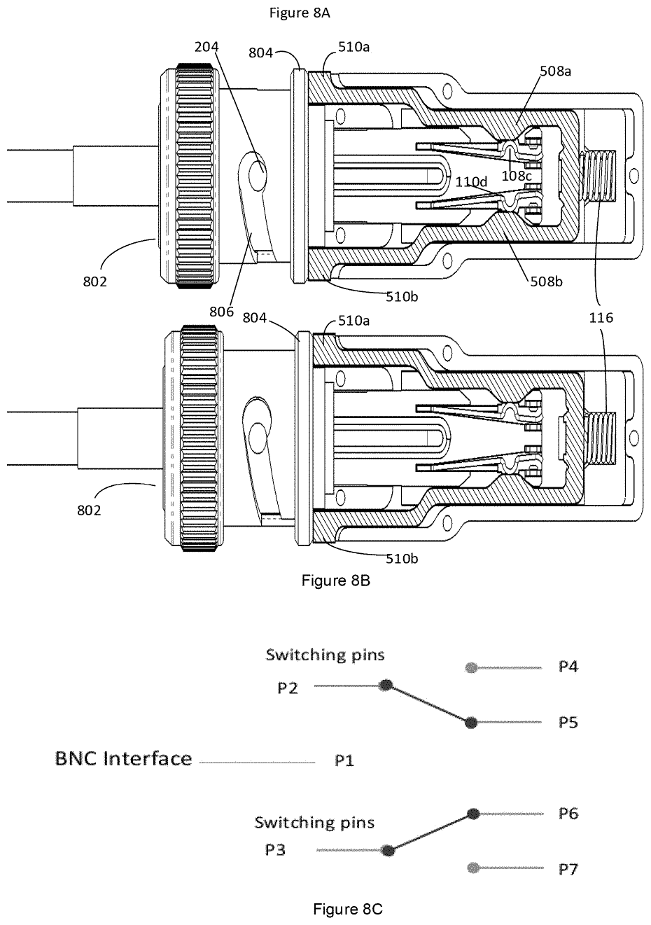

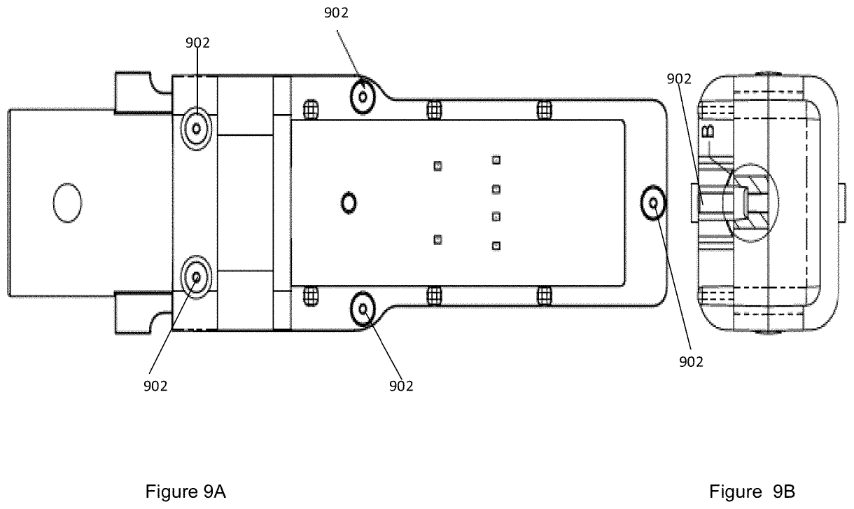

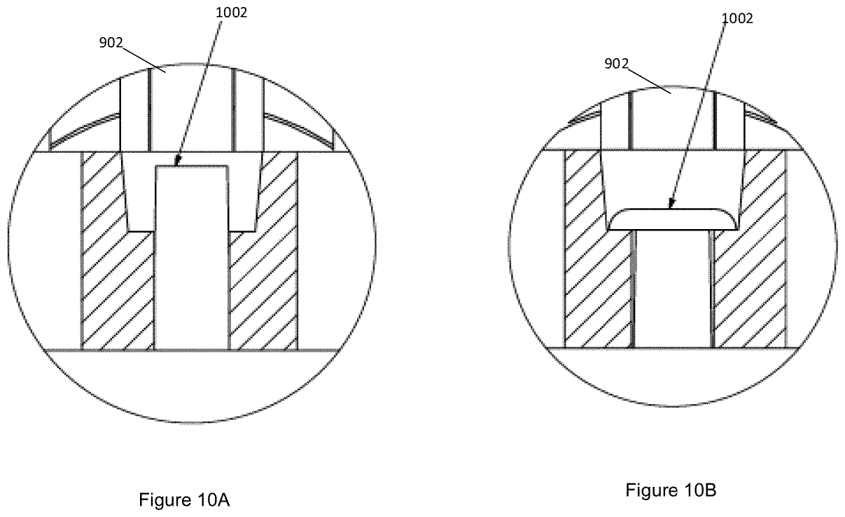

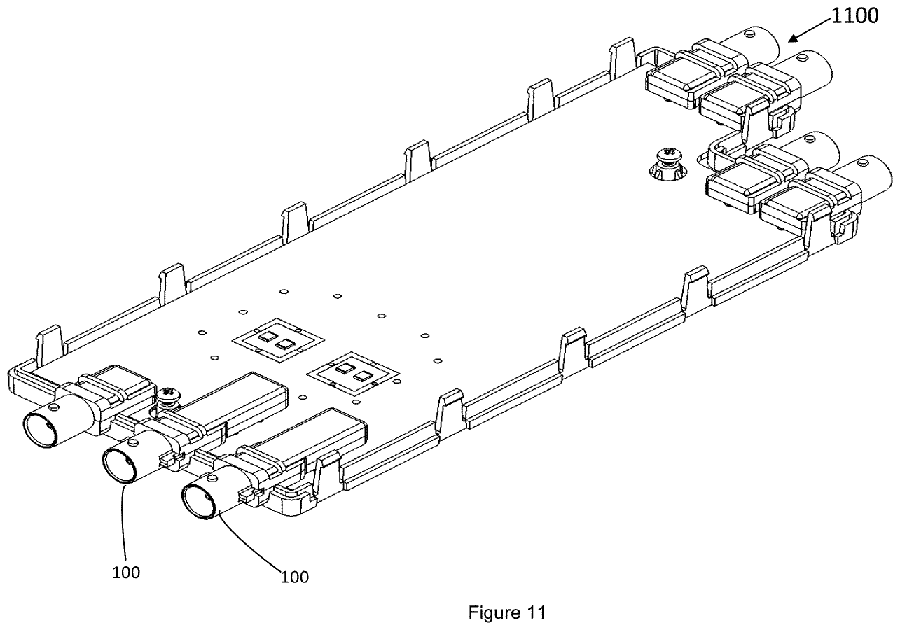

FIG. 8B is a cross-sectional view of the BNC connector in FIG. 1A connected to the plug and before locking to the BNC connector;

FIG. 8C is a switch diagram of the BNC connector in FIGS. 1A-1C, after the BNC plug connected and locked to the BNC connector, according to an embodiment;

FIG. 9A is a bottom view of the BNC connector in FIG. 1A illustrating connectors for assembling the BNC connector, according to an embodiment;

FIG. 9B is a partial cross-sectional view of the BNC connector in FIG. 8A using a riveting, according to an embodiment;

FIGS. 10A and 10B are enlarged partial cross-sectional view of the BNC connector in FIG. 1A before and after riveting, according to an embodiment; and

FIG. 11 is a right perspective view, illustrating the BNC connector in FIGS. 1A assembled on a printed circuit board (PCB), according to an embodiment.

Similar reference numerals may have been used in different figures to denote similar components.

### DESCRIPTION OF EXAMPLE EMBODIMENTS

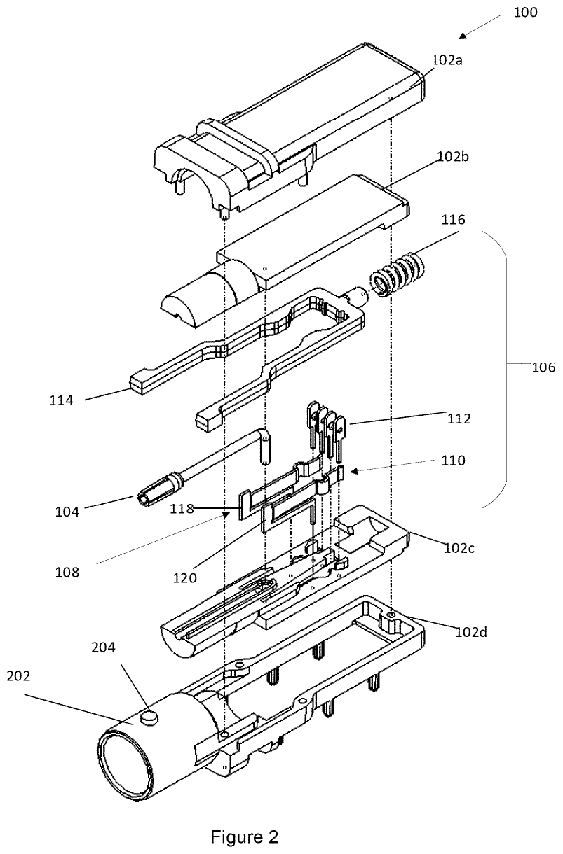

FIGS. 1A, 1B, 1C and 2 illustrate an example of a BNC connector 100. The BNC connector 100 include a dielectric housing 102, a signal receiver 104, and a switch 106.

The BNC connector 100 may be used to quickly connect to or disconnect from a radio frequency signal BNC plug used for coaxial cable. The BNC connector 100 may be a coaxial BNC connector and may have an impedance of 50 Ohm or 75 Ohm. The impedance of the BNC connector 100 may be selected to match for the characteristic impedance of the BNC plug. For example, the BNC connector 100 may be 75 Ohm for video or High Definition (HD) video signals and DS3 Telco central office applications can, and may be 50 Ohm for data and radio frequency signals. The BNC connector 100 can be used for communications or data and/or voice applications, such as a DSX-3 Cross-connect application.

The housing 102 is made from insulating material, and is configured to operably receive the signal receiver 104 and the switch 106. As illustrated in the example of FIG. 2, the housing 102 includes a first cover 102a, a first insulator 102b, a second insulator 102c, and a second cover 102d. The first and second insulators 102b and 102c are configured to securely receive the signal receiver 104 and the switch 106 therein. The second insulator 102c is configured to be securely mounted on the second cover 102d. The first cover 102a is configured to cover the first insulator 102b. The second cover 102d is configured to cover the second insulator 102b. The first cover 102a and the second cover 102d are configured to protect the signal receiver 104 and the switch 106 in an assembled state.

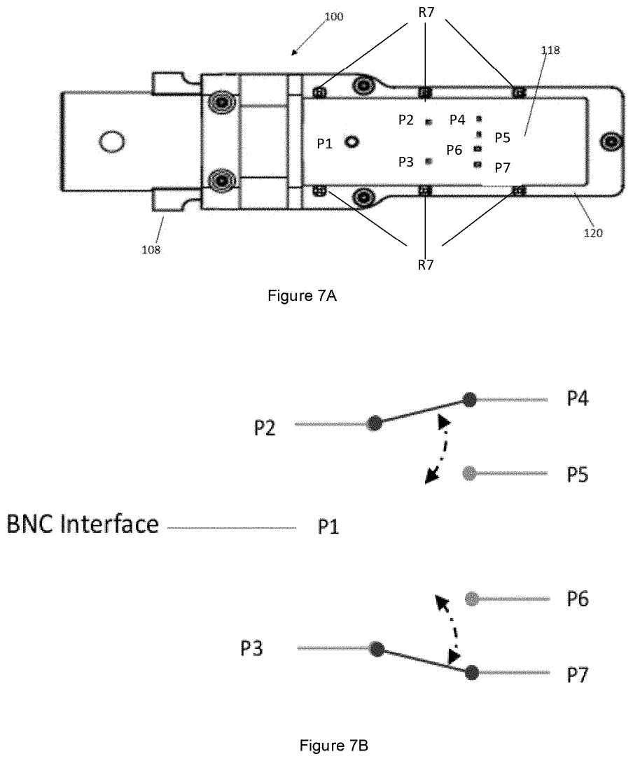

The first insulator 102b and the second insulator 102c are configured to securely receive the signal receiver 104. The signal receiver 104, such as a signal pin, is configured to be securely mounted on the second insulator 102c and covered by the first insulator 102b. The signal receiver 104 is made from conductive material, such as metal, including copper. The signal may be a data signal or a radio frequency signal. The signal receiver 104 can be configured to electrically connect to pin P1 (FIG. 7A). P1 may be configured to electrically connect to a signal circuit on a PCB. The signal receiver 104 is configured to receive a signal from a BNC plug 802 (FIGS. 8A and 8B) when the BNC connector 100 is connected to the BNC plug. The signal receiver 104 may then transmit the signal from the BNC plug 802 to a circuit on the PCB.

The second cover 102d has a cylindrical connector 202 at the front edge of the second cover 102d for receiving the portion of the signal receiver 104 extended from the first insulator 102b and second insulator 102b. The cylindrical connector 202 is configured to be received in the BNC plug 802. The cylindrical connector 202 includes a locking pin 204. In the example of FIGS. 8A and 8B, the locking pin 204 coordinates with a locking slot 806 of the BNC plug 802 to lock the BNC plug 802 to the BNC connector 100, and thus to maintain the connection between the BNC plug 802 and the BNC connector 100.

The switch 106 is configured to be mounted in the housing 102. The switch 106 is configured to transmit signals received from the BNC plug 802 to a circuit on the PCB, when the BNC plug 802 is connected to the BNC connector 100.

As illustrated in the example of FIG. 2, the switch 106 may include a left arm 108, a right arm 110, and a plurality of fixed arms 112, a switch pusher 114, and a biasing means 116, such as a spring. The left arm 108, right arm 110, and fixed arms 112 are made from electrical conductive materials, such as metal.

The left arm 108 and the right arm 110 are configured to electrically switch from the first circuit on a PCB to the second circuit on the PCB. As illustrated in the example of FIG. 2, the left arm 108 is securely mounted on a base 118 and the right arm 110 is securely mounted on a base 120. The bases 118 and 120 are securely mounted on the second insulator 102c. The first and second insulators 102b and 102c are configured to securely enclose left arm 108 and the right arm 110 therein.

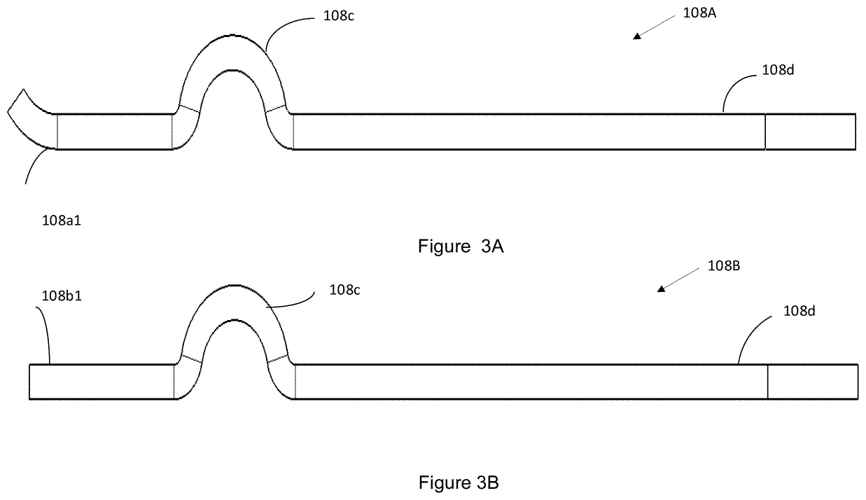

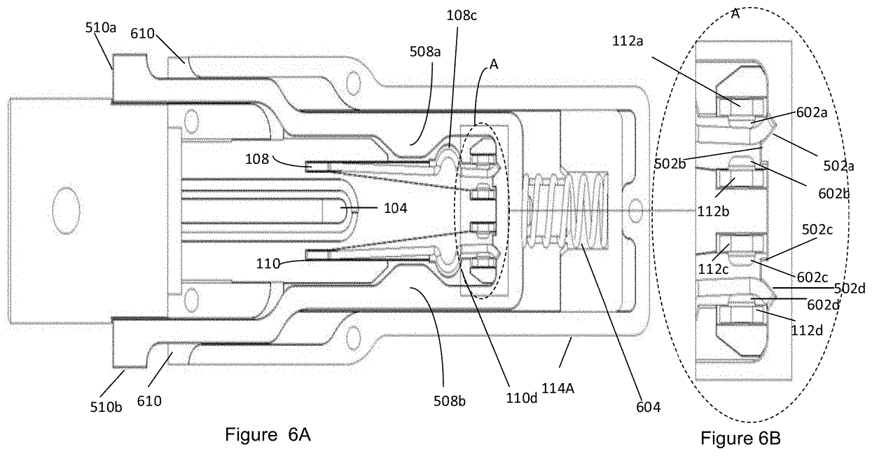

FIG. 3A illustrates an embodiment of a left arm 108A, and FIG. 3B illustrates another embodiment of the left arm 108B. In FIGS. 3A and 3B, the left arm 108 has a rear portion 108a1 or 108b1, a protruded portion 108c, and a front portion 108d for connecting to pin P2 (FIG. 7A). When assembled, the protruded portion 108c extends to a left side of the BNC connector 100. In the embodiment in FIG. 3A, the rear portion 108a1 is curved to a left side. In the embodiment in FIG. 3B, the front portion 108b1 is substantially straight. As illustrated in FIG. 6B, the curved rear portion 108a1 enhances electrical connection with the contact point 602a of the fixed arm 112a by maintaining the curved rear portion 108a1 in the corresponding groove 502a, when the BNC connection 100 is not connected to a BNC plug 802.

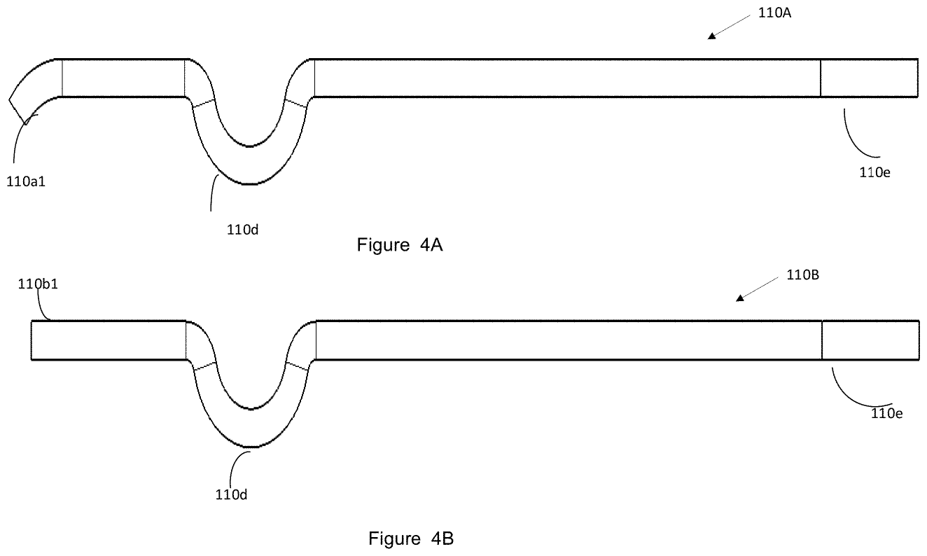

FIG. 4A illustrates an embodiment of a right arm 110A, and FIG. 4B illustrates another embodiment of the left arm 110B. In FIGS. 4A and 4B, the right arm 110 has a rear portion 110a1 or 110b1, a protruded portion 110d, and a front portion 110e for connecting to pin P3 (FIG. 7A). When the right arm 110 is assembled, protruded portion 110d extends to a right side of the BNC connector 100. In the embodiment in FIG. 4A, the front portion 110a1 is slightly curved toward a right side. In the embodiment in FIG. 4B, the front portion 110b1 is substantially straight.

As illustrated in FIG. 6B, the curved rear portion 110a1 enhances electrical connection with the contact point 602d of the fixed arm 112d by maintaining the curved rear portion 110a1 in the corresponding groove 502d, when the BNC connection 100 is not connected to a BNC plug 802.

The fixed arms 112 may include a plurality of conductive arms securely mounted on the second insulator 102c, and covered by the first insulator 102b. The fixed arms 112 are configured to be electrically connected to first and second circuits on a PCB. In the example of FIG. 2, the fixed arms 112 include four arms 112a-112d (FIG. 6B), with two arms configured to connect to a first circuit and the other two arms configured to connect to a second circuit. The left arm 108 and the right arm 110 are configured to respectively connect to two of the four fixed arms 112. The rear portion 108a1 or 108b1 of the left arm 108 is configured to electrically connect to arm 112a or 112b depending on the position of the switch pusher 114. The arm 112a is electrically connected to pin P4 (FIG. 7A) and the arm 112b is electrically connected to pin P5 (FIG. 7A). The rear portion 110a1 or 110b1 of the right arm 110 is configured to electrically connect to arm 112d or 112c depending on the position of the switch pusher 114. The arm 112c is electrically connected to pin P6 (FIG. 7A) and the arm 112d is electrically connected to pin P7 (FIG. 7A). For example, fixed arms 112a and 112d are configured to connect to a first circuit on a PCB via P4 and P7, and fixed arms 112b and 112c are configured to connect to a second circuit on a PCB via P5 and P6. The first and second circuits may be one or more switch circuits, LED, and alternate circuits on a PCB. As illustrated in FIGS. 6A and 6B, each of the fixed arms 112a-112d may include a respective contact point 602a-602d.

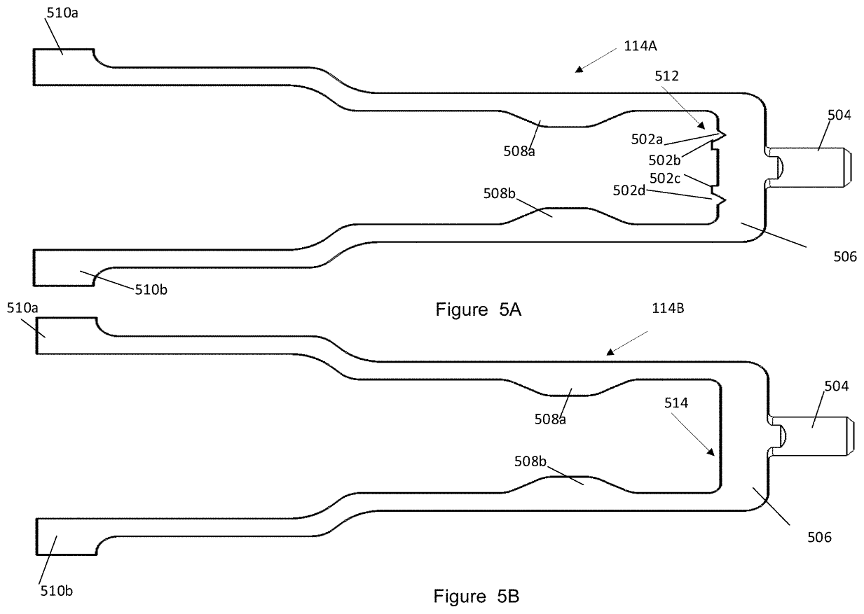

The switch pusher 114 is mounted on the second insulator 102c and covered by the first insulator 102b. The switch pusher 114 configured to be slidable in relation to the left arm 108 and the right arm 110. FIG. 5A illustrates an embodiment of a switch pusher 114A, and FIG. 5B illustrates another embodiment of the switch pusher 114B. The switch pushers 114, including switch pushers 114A and 114B, are configured to be slidably mounted between the first insulator 102b and the second insulator 102c. Each of the switch pusher 114A and 114B includes a front portion 504 and a fork body 506.

As illustrated in the example of FIG. 6A, the front portion 504 is configured to be received in an end of the spring 116. For example, the front portion 504 may be a cylinder configured to be received within the spring 116. The spring 116 is securely received in a cylindrical bore 604 formed by the first insulator 102b and the second insulator 102c. When the BNC connector 100 is in a default position, the spring 116 may be in an initial uncompressed state.

The fork body 506 includes a front inner edge, and two prongs having two rear ends 510a and 510b. The front inner edge may be the front inner edge 512 in the switch pusher 114A, or a front inner edge 514 in the switch pusher 114B. The front inner edge 512 may include a plurality protrusions, such as protrusions 508a and 508b each for receiving a rear end of the left arm 108 or the right arm 110. The two rear ends 510a and 510b of the two prongs are configured to extend outside the edge 610 of the first cover 102a. When the BNC plug 802 is connected to the BNC connector 100, the edge 804 of the BNC plug 802 pushes the rear ends 510a and 510b of the switch pusher 114 and thus pushes front portion 504 inside the cylindrical bore 604. As such, connecting to the BNC plug 802 to the BNC connector 100 makes the switch pusher 114 move in relation to left arm 108 and right arm 110.

In the embodiment of FIG. 5A, the inner front edge 512 of the switch pusher 114A comprises a plurality of the groves 502a and 502d, and two protrusions 502b and 502c. As illustrated in FIG. 6A, the curved rear portions 108a1 and 110a1 are configured to be respective received in grooves 502a and 502d of the switch pusher 114A, when the BNC connector 100 is not connected to a BNC plug 802 or at a default position, to enhance electrical connection with the contact point of the fixed arm 112d and 112a.

As illustrated in FIG. 6A, when the BNC connector 100 is in a default position, the protrusions 508a and 508b are on a left side of the protruded portion 108c of the left arm 108 and the protruded portion 110d of and the right arm 110. As illustrated in FIG. 6B, when the BNC connector 100 is in a default position, the left arm 108 and right arm 110 are biased to respectively connect to the contact point 602a of fixed arm 112a, and the contact point 602d of the fixed arm 112d. In addition to the bias force generated by the protrusions 508a and 508b, the grooves 502a and 502d and the curved rear portions 108a1 and 110a1 additionally maintain the connection between the contact points 602a and 602d and the fixed arms 112a and 112d, respectively.

In the example of FIGS. 6A and 6B, the fixed arm 112b is mounted on a left side of the protrusion 502b, and the contact point 602b faces contact point 602a. The fixed arm 112c is mounted on a right side of the protrusion 502c, and the contact point 602c faces contact point 602d.

In the embodiment of FIG. 5B, the inner front edge 512 of the switch pusher 114B is substantially straight. When the BNC connector 100 is in a default position, the left arm 108 and right arm 110 are biased to respectively connect to the contact point 602a of fixed arm 112a, and the contact point 602d of the fixed arm 112d, by the biasing force generated by the protrusions 508a and 508b on the left arm 108 and right arm 110. The fixed arm 112b is mounted to be adjacent to the fixed arm 112a, and the contact point 602b faces contact point 602a. The fixed arm 112c is mounted to be adjacent to the fixed arm 112d, and the contact point 602c faces contact point 602d.

As illustrated in FIG. 7A, the BNC connector 100 has a plurality conductive pins P1-P7 for connecting to the signal receiver 104, the left arm 108, right arm 110 and the fixed arms 112, and to circuits on a PCB. P1-P7 can be metal pins. The signal receiver 104 is configured to electrically connect to pin 1 (P1). The front end 108d of the left arm 108 is connected to pin P2. The rear end 108a1 or 108b1 is connected to either fixed arm 112a, which is connected to pin P4, or 112b, which is connected to pin P5, depending on the position of the switch pusher 114. The front end 110e of the right arm 110 is connected to Pin P3. The rear end 110a1 or 110b1 of the right arm 110 is connected to either fixed arm 112d, which is connected to pin P7, or 112c, which is connected to pin P6, depending on the position of the pusher. P4 and P7 are configured to connect to a first circuit on the PCB, and P5 and P6 are configured to connect to a second circuit on the PCB. In some examples, P1 may electrically connect to P2, P3, or P2 and P3 via one or more circuits on the PCB. As such, the signal from the receiver 104 may be transmitted via P1 to the left arm 108 connected to P2, and/or the right arm 110 connected to P3, to the first and/or second circuit. Pins P1-P7 may be through-hole pins for printed circuit board application.

The configuration of the BNC connector 100 allows multiple variations of the received signal path to be connected to one or more of circuits on a PCB, as illustrated in FIG. 11, or have the circuits, such as first circuit and second circuit, act as isolated circuits that are dictated by the insertion and removal of the mating BNC plug 802. An example of an isolated circuit, such as the first circuit or second circuit, can be the activation of an LED or alternate circuit when a BNC plug 802 is plugged into the BNC connector 100.

As illustrated in FIG. 7B, when the BNC connector 100 is in a default position, the left arm 108 is configured to connect P2 to P4, and the right arm 110 is configured to connection P3 to P7. P4 and P7 are configured to connect to a first circuit on a PCB. The first circuit may be one or more switch circuits, LED circuits, and alternate circuits on the PCB.).

FIG. 8A illustrates that a BNC plug 802 is connected to the BNC connector 100. FIG. 8B illustrates that the BNC plug 802 is to be turned counter-clockwise for locking on the BNC connector 100. As illustrated in the embodiment in FIGS. 8A-8C, when the BNC plug 802 is connected to the BNC connector 100, the edge 804 of the BNC plug 802 pushes the ends 510a and 510b and thus push the switch pushers 114A and 114B inside to the cylindrical bore 604. The front potion 504 in turn compresses the spring 116 to a compressed state.

As well, when the switch pusher 114A or 114B is pushed inside toward the cylindrical bore 604, the protrusion 508a is configured to bias the protruded portion 108c of the left arm 108, and the protrusion 508b is configured to bias the protruded portion 110d of the right arm 110. As such, when the BNC connector 100 is connected to the BNC plug 802, as illustrated in FIGS. 8A-8B, the rear portion 108a1 of the left arm 108A electrically is connected to the contact point 602b of the fixed arm 112b, and the rear portion 110a1 of the right arm 110A electrically is connected to the contact point 602c of the fixed arm 112c.

Similarly, when the left arm 108b and right arm 110b are used in the BNC connector 100, when the BNC connector 100 is connected to the BNC plug 802, the rear portion 108b1 of the left arm 108B electrically connected to the contact point 602b of the fixed arm 112b, and the rear portion 110b1 of the right arm 110B electrically connected to the contact point 602c of the fixed arm 112c.

When the BNC connector 100 is connected to the BNC plug 802, as illustrated in FIG. 8C, the left arm 108 is configured to connect P2 to P5, and the right arm 110 is configured to connection P3 to P6. P5 and P6 are configured to connect to a second circuit on a PCB. The second circuit may be one or more switch circuits, LED, and alternate circuits on the PCB.

When the BNC plug 802 is removed from the BNC connector 100, the spring 116 pushes the switch pusher 114 outward away from the bore 604 until the spring 116 resumes to its initial state. Accordingly, the protrusion 508a moves outward in relation to the protruded portion 108c of the left arm 108, and the protrusion 508b moves outward in relation to the protruded portion 110d of the right arm 110, and the BNC connector 100 resumes to the default position. As such, the left arm 108 is configured to connect P2 to P4, and the right arm 110 is configured to connect P3 to P7. P4 and P7 are configured to connect to the first circuit on a PCB.

As described above, the first cover 102a and the second cover 102d are configured to protect the signal receiver 104 and the switch 106 in an assembled state. As illustrated in FIG. 9A, the first cover 102a and the second cover 102d may connect with each other at selected connection points 902 with connectors. The connectors may be rivets or screws. FIG. 9B illustrates an example where a rivet B is used to securely connect the first cover 102a to the second cover 102d at a connection point 902.

As illustrated in FIG. 7A, the BNC connector 100 may include a plurality of connectors on the second cover 102d, such as R7, for securely connecting the BNC connector 100 to a PCB board.

FIG. 10A illustrates an example where a rivet 1002 is inserted into a connection point 902. FIG. 10B illustrates an example where the rivet 1002 is fixed at the connection point 902.

As illustrated in FIG. 11, one or more assembled BNC connectors 100 may be mounted on a PCB 1100. For example, the PCB 1100 may be a DSX-3 Cross-connect application to simplify the functional operation. Simplification is achieved by the elimination of external switches, linkages between switches and BNC plug 802, RF shielding of external components and the need for space on the PCB 1100. A BNC connector 100 may be mounted on the PCB 1100 by soldering the P1-P7 on the PCB board.

Certain adaptations and modifications of the described embodiments can be made. Therefore, the above discussed embodiments are considered to be illustrative and not restrictive.

What is claimed is:

1. A Bayonet Neill-Concelman (BNC) connector, comprising:
an insulating housing;
a signal receiver mounted in the housing for receiving a signal from a BNC plug; and
a switch mounted in the housing and configured to connect to a first circuit on a PCB (Printed Circuit Board), and when the BNC plug is connected to the BNC connector, the switch configured to connect to a second circuit on the PCB.

2. The BNC connector of claim 1, wherein the switch comprises a left arm and a right arm configured to selectively connect to the first circuit and the second circuit.

3. The BNC connector of claim 2, wherein each of the left arm and the right arm has a rear portion, a front portion for connecting to the signal recover, and a protruded portion between the rear portion and the front portion.

4. The BNC connector of claim 3, wherein the front portion is substantially straight, and the rear portion is curved to a left or a right side.

5. The BNC connector of claim 3, wherein the switch further comprises a first pair of fixed arms configured to connect to the first circuit, a second pair of fixed arms configured to connect to the second circuit, and wherein the left arm and the right arm are configured to selectively connect to the first pair of fixed arms and the second pair of fixed arms.

6. The BNC connector of claim 3, wherein each of the first pair of fixed arms and the second pair of fixed arms has a contact point.

7. The BNC connector of claim 3, wherein the switch further comprises a pusher, and wherein when the BNC plug is connected to the BNC connector, the pusher is configured to be slidable in relation to the left arm and the right arm to cause the left arm and the right arm to connect from the first circuit to the second circuit.

8. The BNC connector of claim 7, wherein the pusher comprises a left prong and a right prong, each having a protrusion, wherein when the BNC plug is connected to the BNC connector, the protrusion of the left prong is configured to engages the protruded portion of the left arm, and the protrusion of the right prong is configured to engages the protruded portion of the right arm.

9. The BNC connector of claim 7, wherein the switch further comprises a biasing means for biasing the pusher, the biasing means configured to be in a compressed state when the BNC plug is connected to the BNC connector, and in a uncompressed state when the BNC plug is disconnected from the BNC connector.

10. The BNC connector of claim 9, wherein the biasing means is a spring.

11. The BNC connector of claim 9, wherein the pusher comprises a front portion received in the spring.

12. The BNC connector of claim 8, wherein the pusher comprises a front inner edge between the left prong and the right prong.

13. The BNC connector of claim 12, wherein the front inner edge is substantially straight.

14. The BNC connector of claim 13, wherein the front inner edge comprises a left protrusion for receiving a rear end of the left arm, and a right protrusion for receiving a rear end of the right arm.

15. The BNC connector of claim 13, wherein the left protrusion and the rear end of the left arm are curved, and the right protrusion and the rear end of the right arm are curved.

16. The BNC connector of claim 8, wherein each of the left prong and the right prong has a rear end configured to engage an edge of the BNC plug.

17. The BNC connector of claim 5, further comprising a plurality conductive pins connecting to the signal receiver, the left arm, the right arm, the first pair of fixed arms, and the second pair of fixed arms.

18. The BNC connector of claim 17, wherein first two conductive pins are configured to connect to the first circuit on a PCB, and wherein second two conductive pins are configured to connect to the second circuit on the PCB.

19. The BNC connector of claim 17, wherein the insulating housing comprises first and second insulators configured to securely receive the signal receiver and the switch.

20. The BNC connector of claim 1, wherein further comprising a locking mechanism for retaining the spring in a compressed state when the BNC plug is secured to the BNC connector.
